(19) United States
(12) Patent Application Publication
(10) Pub. No.: US 2026/0131623 A1
(43) Pub. Date: May 14, 2026

(54) VEHICLE AIR CONDITIONING SYSTEM

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/358,650

(22) Filed: Oct. 15, 2025

(30) Foreign Application Priority Data
Nov. 11, 2024 (JP) 2024-196876

(51) Int. Cl. B60H 1/00

(52) U.S. Cl. CPC B60H 1/00671

(57) ABSTRACT

A vehicle air conditioning system according to this invention includes: a flow path through which inside air in a vehicle interior and/or outside air from a vehicle exterior can flow; at least one humidity controlling device provided in the flow path, the humidity controlling device being configured to adsorb and desorb moisture; an HVAC unit including a damper configured to adjust a percentage of an amount of the inside air and an amount of the outside air introduced; and a control unit configured to control the humidity controlling device and the HVAC unit. The control unit controls the damper so that the amount of the inside air introduced is greater than the amount of the outside air introduced, during execution of heating by the HVAC unit and dehumidification by the humidity controlling device.

### CROSS REFERENCE TO RELATED APPLICATIONS

This application claims the benefit of priority to Japanese Patent Application No 2024-196876 filed on Nov. 11, 2024 with the Japanese Patent Office, the entire contents of which are incorporated herein by reference in its entirety.

### FIELD OF THE INVENTION

The present invention relates to a vehicle air conditioning system.

### BACKGROUND OF THE INVENTION

In various types of vehicles such as automobiles, there are increasing requirements for improvement of vehicle interior environment. Specific requirements illustrate reduction of an amount of CO₂ in a vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

As a method for solving the above problems, a vehicle purifying system (vehicle air conditioning system) is proposed, which includes: a heater element (humidity controlling device) including a honeycomb structure having an outer peripheral wall and partition walls provided on an inner side of the outer peripheral wall, the partition walls defining a plurality of cells each extending from one end face to other end face of the honeycomb structure to form a flow path, at least the partition wall being made of a material having a PTC property; a pair of electrodes including a first electrode provided on the one end face and a second electrode provided on the other end face; and a functional material-containing layer provided on a surface of each partition wall; as well as an inflow pipe communicating a vehicle interior with an inlet end face of the heater element; and an outflow pipe having a first path (first flow path) that communicates an outlet end face of the heater element with the vehicle interior, wherein the outflow pipe has a first path that communicates an outlet end face of the heater element with the vehicle interior and a second path (second flow path) that communicates the outlet end face of the heater element with a vehicle exterior, and wherein the system includes a switching valve configured to switch an air flow circulating through the outflow pipe between the first path and the second path (for example, Patent Literature 1).

On the other hand, an air conditioning system provided with an HVAC (Heating, Ventilation and Air Conditioning) unit using a heat pump cycle has been proposed as an air conditioning system that can perform heating and cooling of a vehicle (e.g., Patent Literatures 2 and 3).

In a vehicle air conditioning system including a humidity controlling device and an HVAC unit, there are problems that, if the humidity controlling device dehumidifies the vehicle interior while introducing a large amount of outside air during heating by the HVAC unit, the vehicle interior may become excessively dehumidified and the energy consumption for heating may increase.

This invention was made to solve the problems as described above. An object of the invention is to provide a vehicle air conditioning system that can reduce the energy consumption while ensuring suitable dehumidification performance during heating.

### PRIOR ART

### Patent Literatures

[Patent Literature 1] WO 2023/074202 A1
[Patent Literature 2] Japanese Patent No. 6746742 B
[Patent Literature 3] Japanese Patent Application Publication No. 2016-097817 A

### SUMMARY OF THE INVENTION

As a result of extensive studies for vehicle air conditioning systems including humidity controlling devices and HVAC units, the inventor has found that the problems described above can be solved by controlling a damper in the HVAC unit so that an amount of inside air introduced is greater than an amount of outside air introduced during execution of the heating by the HVAC unit and the dehumidification by the humidity controlling device. In other words, this invention is exemplified as follows:

<1> A vehicle air conditioning system including:
a flow path through which inside air in a vehicle interior and/or outside air from a vehicle exterior can flow;
at least one humidity controlling device provided in the flow path, the humidity controlling device being configured to adsorb and desorb moisture;
an HVAC unit including a damper configured to adjust a percentage of an amount of the inside air and an amount of the outside air introduced; and
a control unit configured to control the humidity controlling device and the HVAC unit,
wherein the control unit controls the damper so that the amount of the inside air introduced is greater than the amount of the outside air introduced, during execution of heating by the HVAC unit and dehumidification by the humidity controlling device.

<2> The vehicle air conditioning system according to <1>, wherein the control unit may control the damper so that a percentage of the amount of the inside air introduced is 55% or more, during execution of the heating by the HVAC unit and the dehumidification by the humidity controlling device.

<3> The vehicle air conditioning system according to <1>, wherein the control unit may control the damper so that a percentage of the amount of the inside air introduced is 70% or more, during execution of the heating by the HVAC unit and the dehumidification by the humidity controlling device.

<4> The vehicle air conditioning system according to any one of <1> to <3>, wherein the humidity controlling device may be provided on a downstream side of the damper in the HVAC unit.

<5> The vehicle air conditioning system according to any one of <1> to <3>, wherein the humidity controlling device may be provided on an upstream side of the HVAC unit.

<6> The vehicle air conditioning system according to any one of <1> to <5>, wherein the HVAC unit may include a condenser, and the condenser is connected to a heat pump cycle.

<7> The vehicle air conditioning system according to any one of <1> to <6>, wherein, on a downstream side of the humidity controlling device, the flow path may branch into a first flow path for allowing the inside air and/or the outside air to flow into the vehicle interior and a second flow path for allowing the inside air and/or the outside air to flow to the vehicle exterior, and
wherein the vehicle air conditioning system further includes a first valve configured to switch the flow of the inside air and/or the outside air between the first flow path and the second flow path.

<8> The vehicle air conditioning system according to any one of <1> to <7>, wherein the humidity controlling device may include: an adsorption portion containing an adsorbent configured to adsorb moisture at a temperature lower than or equal to a predetermined temperature and desorb the adsorbed moisture when the temperature exceeds the predetermined temperature; and a heating means or a heating structure configured to heat the adsorption portion.

<9> The air conditioning system according to <8>, wherein the humidity controlling device may include:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for air;
an adsorbing layer containing the adsorbent, the adsorbing layer being provided on a surface of each of the partition walls; and
a pair of electrodes provided on the first end face and the second end face of the honeycomb structure, or on the outer peripheral wall parallel to an extending direction of the cells of the honeycomb structure.

<10> The vehicle air conditioning system according to <9>, wherein at least the partition walls of the honeycomb structure may be made of a material having a PTC property.

<11> The vehicle air conditioning system according to <8>, wherein the humidity controlling device may have a flow path for air and a flow path for a heating medium adjacent to the flow path for the air, and wherein the adsorption portion is provided in the flow path for the air.

<12> The vehicle air conditioning system according to <8>, wherein the humidity controlling device may include:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for air;
an adsorbing layer containing the adsorbent, the adsorbing layer being provided on a surface of each of the partition walls; and
a heater provided on an upstream side of the honeycomb structure.

<13> The vehicle air conditioning system according to any one of <1> to <12>, wherein the vehicle air conditioning system may be used for an electric vehicle, a hybrid vehicle, or a plug-in hybrid vehicle.

### BRIEF DESCRIPTION OF THE DRAWINGS

FIG. 1 is a schematic configuration view of a vehicle air conditioning system according to an embodiment;

FIG. 2 is a schematic configuration view of another vehicle air conditioning system according to an embodiment;

FIG. 3 is a schematic configuration view of another vehicle air conditioning system according to an embodiment;

FIG. 4 is a schematic configuration view of another vehicle air conditioning system according to an embodiment;

FIG. 5 is a schematic configuration view of another vehicle air conditioning system according to an embodiment;

FIG. 6A is a schematic view of a cross section of a typical humidity controlling device used in a vehicle air conditioning system according to an embodiment of the present invention, which is parallel to a flow path direction; and

FIG. 6B is a schematic cross-sectional view of the humidity controlling device taken along the line a-a′ in FIG. 6A; and

FIG. 7 is a schematic view of a heat pump cycle.

### DETAILED DESCRIPTION OF THE INVENTION

A vehicle air conditioning system according to this invention includes: a flow path through which inside air in a vehicle interior and/or outside air from a vehicle exterior can flow; at least one humidity controlling device provided in the flow path, the humidity controlling device being configured to adsorb and desorb moisture; an HVAC unit including a damper configured to adjust a percentage of an amount of the inside air and an amount of the outside air introduced; and a control unit configured to control the humidity controlling device and the HVAC unit. The control unit controls the damper so that the amount of the inside air introduced is greater than the amount of the outside air introduced, during execution of heating by the HVAC unit and dehumidification by the humidity controlling device.

If a large amount of cold outside air is introduced even though the humidity controlling device is dehumidifying during heating by the HVAC unit, excessive dehumidification may occur or an amount of energy consumed to heat the outside air may increase. Further, if a large amount of the outside air is introduced when the humidity in the vehicle interior increases suddenly due to an increase in a number of passengers or bringing rain or snow from the vehicle exterior into the vehicle interior during the heating by the HVAC unit to cause the window glass to fog up, a large amount of energy may be consumed to heat the outside air. Therefore, with the above configuration, the vehicle air conditioning system according to this invention can reduce the energy consumption while ensuring suitable dehumidification performance during heating.

Hereinafter, embodiments of the invention will be specifically described with reference to the drawings. It should be understood that the invention is not limited to the following embodiments, and those which have appropriately added changes, improvements and the like to the following embodiments based on knowledge of a person skilled in the art without departing from the spirit of the invention fall within the scope of the invention.

The vehicle air conditioning system according to an embodiment of the present invention can be suitably utilized for various vehicles such as automobiles. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. The vehicle air conditioning system according to an embodiment of this invention can be suitably used for an electric vehicle, a hybrid vehicle, or a plug-in hybrid vehicle.

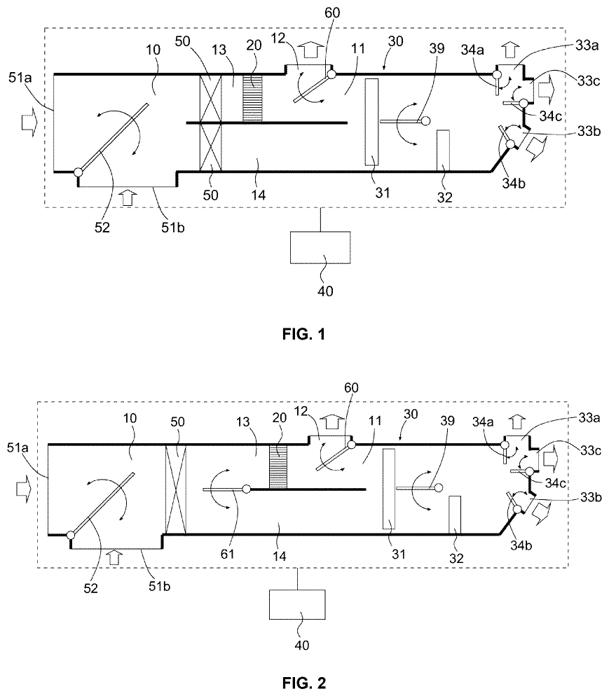

FIGS. 1 to 5 are schematic configuration views of a vehicle air conditioning system according to an embodiment.

The vehicle air conditioning system illustrated in FIGS. 1 to 5 includes: a flow path 10 through which inside air in the vehicle interior and/or outside air from the vehicle exterior can flow; at least one humidity controlling device 20 provided in the flow path 10; an HVAC unit 30 including a damper 52 configured to adjust a percentage of amounts of the inside air and the outside air introduced; and a control unit 40 configured to control the humidity controlling device 20 and the HVAC unit 30.

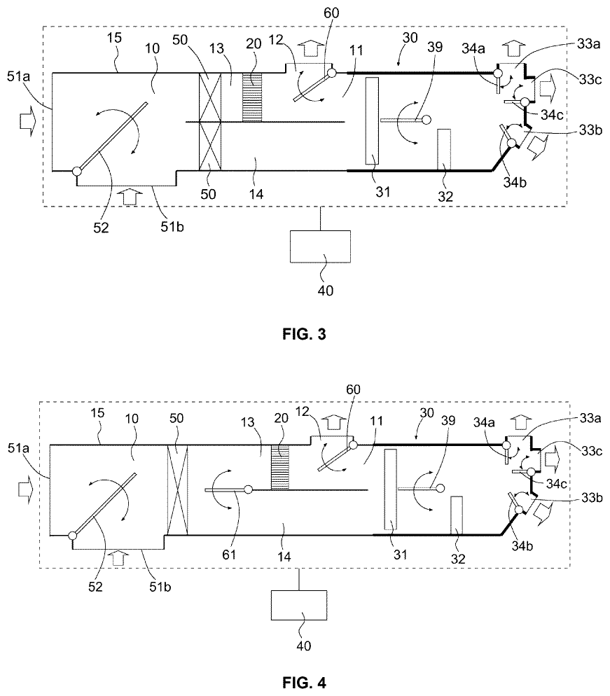

Here, FIGS. 1 to 2 illustrate an embodiment in which the humidity controlling device 20 is provided inside the HVAC unit 30, specifically, an embodiment in which the humidity controlling device 20 is provided on a downstream side of the damper 52 in the HVAC unit 30. Also, FIGS. 3 to 5 illustrate an embodiment in which the humidity controlling device 20 is provided outside the HVAC unit 30, specifically, an embodiment in which the humidity controlling device 20 is provided on an upstream side of the HVAC unit 30.

The vehicle air conditioning system according to an embodiment is not limited to these embodiments, and the position of the humidity controlling device 20 can be changed as long as the effects of this invention are not impaired. The terms “upstream side” and “downstream side” as used herein are based on a flow direction of the air.

In the vehicle air conditioning system having the above structure, the control unit 40 controls the damper 52 so that the amount of the inside air introduced is greater than the amount of the outside air introduced, during execution of heating by the HVAC unit 30 and dehumidification by the humidity controlling device 20. Such control allows problems such as excessive dehumidification due to the introduction of the outside air and increased energy consumption for heating the outside air to be suppressed. Therefore, energy consumption can be reduced while ensuring suitable dehumidification performance during heating.

As used herein, the heating by the HVAC unit 30 means that the air (inside air and/or outside air) is heated by a condenser 32 of the HVAC unit 30. Therefore, the HVAC unit 30 includes the condenser 32, and the condenser 32 is preferably connected to a heat pump cycle. Also, as used herein, a cooling by the HVAC unit 30 means that the air is cooled by an evaporator 31 of the HVAC unit 30. Therefore, the HVAC unit 30 includes the evaporator 31, and the evaporator 31 is preferably connected to the heat pump cycle.

As used herein, dehumidification by the humidity controlling device 20 means adsorption of moisture from the air by allowing the air (inside air and/or outside air) to flow through the humidity controlling device 20.

It is preferable that the control unit 40 controls the damper 52 so that the percentage of the amount of the inside air introduced is 55% or more, during execution of the heating by the HVAC unit 30 and the dehumidification by the humidity control device 20, it is more preferable that it controls the damper 52 so that the percentage of the amount of the inside air introduced is 70% or more. By controlling the percentage of the amount of the inside air introduced in the above range, it is possible to stably ensure the effects of suppressing excessive dehumidification and reducing energy consumption. Although the upper limit of the amount of the inside air introduced is not particularly limited, it may be, for example, 98%, and preferably 95%.

As used herein, a percentage of an amount of inside air introduced means a ratio of the inside air introduced to the total amount of the outside air and the inside air introduced.

Each of the above components and other components will be described below in detail.

### (1. Flow Path 10)

The flow path 10 is a region where the air (inside air and/or outside air) can flow therethrough and is comprised of a housing and ducts 15 (pipes) of the HVAC unit 30. For example, in the vehicle air conditioning system illustrated in FIGS. 1 and 2, the flow path 10 is comprised of the housing of the HVAC unit 30. The vehicle air conditioning system illustrated in FIGS. 3 to 5 is composed of the housing of the HVAC unit 30 and a duct 15.

The shape and size of the flow path 10 are not particularly limited and may be appropriately adjusted depending on the type of the HVAC unit 30 and the duct 15 connected thereto.

It is preferable that, on a downstream side of the humidity controlling device 20, the flow path 10 branches into a first flow path 11 for allowing the inside air and/or the outside air to flow into the vehicle interior and a second flow path 12 for allowing the inside air and/or the outside air to flow out to the vehicle exterior, and further includes a first valve 60 that can switch the flow of the inside air and/or the outside air between the first flow path 11 and the second flow path 12. With such a configuration, the dehumidification process by the humidity controlling device 20 and the regeneration process of the humidity controlling device 20 can be easily achieved.

The flow path 10 preferably branches on an upstream side of the evaporator 31 into a third flow path 13 that is provided with the humidity controlling device 20 and a fourth flow path 14 that is not provided with the humidity controlling device 20. Such a configuration allows the air (inside air and/or outside air) to be constantly circulated through the HVAC unit 30 to perform heating and cooling even if the humidity controlling device 20 is regenerated.

In the vehicle air conditioning systems illustrated in FIGS. 1, 3 and 5, it is preferable to further include a ventilation fan 50 in the third flow path 13 on an upstream side of the humidity controlling device 20. With this configuration, the air can be selectively allowed to flow through the third flow path 13.

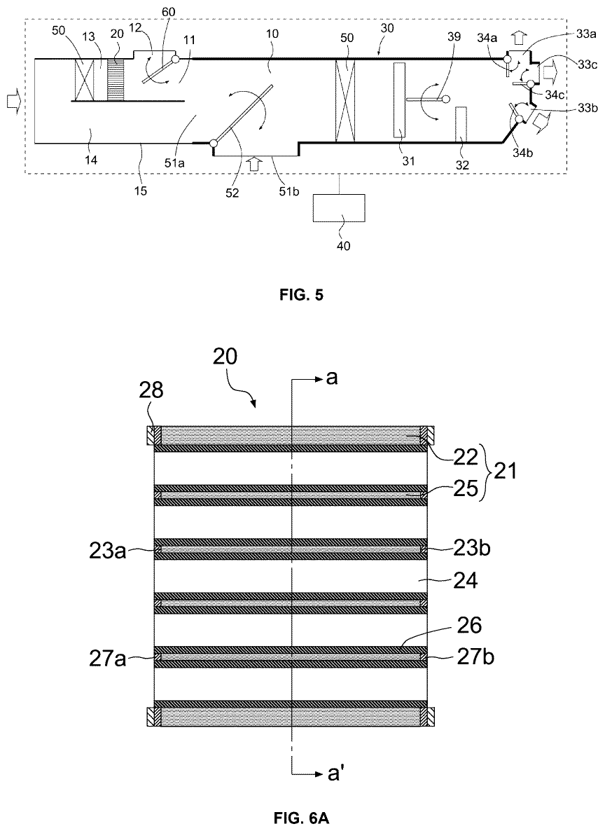

The vehicle air conditioning system illustrated in FIGS. 1 and 3 preferably further includes the ventilation fan 50 in the fourth flow path 14. With this configuration, the air can be selectively allowed to flow through the fourth flow path 14. It should be note that, in the vehicle air conditioning system illustrated in FIG. 5, the air can be selectively allowed to flow through the fourth flow path 14 or both the third flow path 13 and the fourth flow path 14 by activating the ventilation fan 50 of the HVAC unit 30.

The vehicle air conditioning systems illustrated in FIGS. 2 and 4 preferably further include a second valve 61 capable of switching the flow of the air between the third flow path 13 and the fourth flow path 14 on an upstream side of the humidity controlling device 20. The second valve 61 allows the air to selectively flow through the third flow path 13 or the fourth flow path 14. In this case, the ventilation fan 50 may be provided on an upstream side of the second valve 61, as illustrated in FIGS. 2 and 4.

### (2. Humidity Controlling Device 20)

The humidity controlling device 20 is provided in the flow path 10.

The humidity controlling device 20 is not particularly limited as long as it can adsorb and desorb the moisture, but it preferably includes: an adsorption portion containing an adsorbent configured to adsorb the moisture at a temperature lower than or equal to a predetermined temperature and desorb the adsorbed moisture when the temperature exceeds the predetermined temperature; and a heating means or a heating structure configured to heat the adsorption portion. The humidity controlling device 20 having these features can easily achieve adsorption and desorption of moisture.

Also, the number of humidity controlling devices 20 provided in the flow path 10 may be one or more than one. When more than one humidity controlling devices 20 are provided, they may be arranged in parallel to or in series with the flow of the air flowing through the flow path 10.

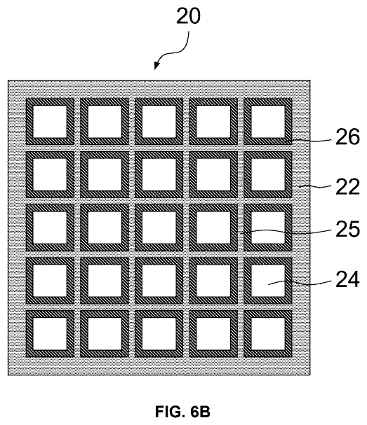

FIG. 6A is a schematic view of a cross section of a typical humidity controlling device used in a vehicle air conditioning system according to an embodiment of the present invention, which is parallel to a flow path direction. FIG. 6B is a schematic cross-sectional view of the humidity controlling device in FIG. 6A taken along the line a-a′.

The humidity controlling device 20 as illustrated in FIGS. 6A and 6B includes: a honeycomb structure 21 having an outer peripheral wall 22 and partition walls 25 provided on an inner side of the outer peripheral wall 22, the partition walls 25 defining a plurality of cells 24 each extending from a first end face 23a to a second end face 23b of the honeycomb structure 21 to form a flow path for air; an adsorbing layer 26 containing an adsorbent, the adsorbing layer 26 being provided on a surface of each of the partition walls 25; and a pair of electrodes 27a, 27b provided on the first end face 23a and the second end face 23b of the honeycomb structure 21. Although not illustrated, the pair of electrodes 27a, 27b may be provided on the outer peripheral wall 22 parallel to the extending direction of the cells 24 of the honeycomb structure 21. Also, terminals 28 may be connected to the pair of electrodes 27a, 27b, respectively.

In addition, the pair of electrodes 27a, 27b can be electrically connected to the control unit 40 via a power source (not shown). Therefore, the humidity controlling device 20 can adjust the state of the voltage applied to the pair of electrodes 27a, 27b according to instructions from the control unit 40. The power source is not particularly limited, and a battery or the like can be used.

### (2-1. Honeycomb Structure 21)

The shape of the honeycomb structure 21 is not particularly limited. For example, an outer shape of a cross section of the honeycomb structure 21 orthogonal to the flow path direction (extending direction of the cells 24) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 23a and second end face 23b) have the same shape as the cross section. Also, when the cross section and the end faces are polygonal, the corners may be chamfered.

The shape of each cell 24 is not particularly limited, but it may be polygonal such as quadrangular (rectangular, square), pentagonal, hexagonal, heptagonal, and octagonal, circular, or oval in the cross section of the honeycomb structure 21 orthogonal to the flow path direction. These shapes may be alone or in combination of two or more. Moreover, among these shapes, the quadrangle or the hexagon is preferable. By providing the cells 24 having such a shape, it is possible to reduce the pressure loss when the air flows.

The honeycomb structure 21 may be a honeycomb joined body that includes a plurality of honeycomb segments and joining layers that join outer peripheral side surfaces of the plurality of honeycomb segments together. The use of the honeycomb joined body can increase the total cross-sectional area of the cells 24, which is important for ensuring the flow rate (flow velocity) of the air, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer peripheral wall 22 and the partition walls 25. In addition to the role of joining the honeycomb segments to each other, the joining material can also be used as an outer peripheral coating material after joining the honeycomb segments.

From the viewpoints of ensuring the strength of the honeycomb structure 21, reducing a pressure loss when the air passes through the cells 24, ensuring the amount of the adsorbent supported, and ensuring the contact area with the air flowing inside the cells 24, it is desirable to suitably combine a thickness of the partition wall 25, a cell density, and a cell pitch (or an opening ratio of the cells 24).

As used herein, the cell density refers a value obtained by dividing a number of cells by an area of one end face (first end face 23a or second end face 23b) of the honeycomb structure 21 (the total area of the partition walls 25 and the cells 24 excluding the outer peripheral wall 22).

As used herein, the cell pitch refers to a value obtained by the following calculation. First, the area of one end face (first end face 23a or second end face 23b) of the honeycomb structure 21 (the total area of the partition walls 25 and the cells 24 excluding the outer peripheral wall 22) is divided by the number of the cells to calculate an area per a cell. A square root of the area per a cell is then calculated, and this is determined to be the cell pitch.

As used herein, the opening ratio of the cells 24 refers a value obtained by dividing the total area of the cells 24 defined by the partition walls 25 by the area of one end face (first end face 23a or second end face 23b) (the total area of the partition walls 25 and the cells 24 excluding the outer peripheral wall 22) in the cross section orthogonal to the flow path direction of the honeycomb structure 21. It should be noted that when calculating the opening ratio of the cells 24, the pair of electrodes 27a, 27b, and the adsorbing layer 26 are not taken into account.

In an embodiment that is advantageous from the viewpoint of supporting a sufficient amount of functional material, the thickness of the partition walls 25 is 0.300 mm or less, the cell density is 100 cells/cm² or less, and the cell pitch is 1.0 mm or more. In a preferred embodiment, the thickness of the partition walls 25 is 0.200 mm or less, the cell density is 70 cells/cm² or less, and the cell pitch is 1.2 mm or more. In a more preferred embodiment, the thickness of the partition walls 25 is 0.130 mm or less, the cell density is 65 cells/cm² or less, and the cell pitch is 1.3 mm or more.

From the viewpoints of ensuring the strength of the honeycomb structure 21 and maintaining lower electrical resistance, the lower limit of the thickness of the partition wall 25 is preferably 0.010 mm or more, more preferably 0.020 mm or more, and even more preferably 0.030 mm or more.

From the viewpoints of ensuring the strength of the honeycomb structure 21, maintaining lower electrical resistance, and increasing a surface area to facilitate reaction, adsorption, and desorption, the lower limit of the cell density is 30 cells/cm² or more, and preferably 35 cells/cm² or more, and even more preferably 40 cells/cm² or more.

From the viewpoints of ensuring the strength of the honeycomb structure 21, maintaining lower electrical resistance and increasing a surface area to facilitate reaction, adsorption and separation, the upper limit of the cell pitch is 2.0 mm or less, more preferably 1.8 mm or less, and even more preferably 1.6 mm or less.

In an embodiment that is advantageous in terms of both reducing pressure loss and maintaining strength, the thickness of the partition walls 25 is 0.08 to 0.36 mm, the cell density is 2.54 to 140 cells/cm², and the opening ratio of the cells 24 is 0.70 or more. In a preferred embodiment, the thickness of the partition walls 25 is 0.09 to 0.35 mm, the cell density is 15 to 100 cells/cm², and the opening ratio of the cells 24 is 0.80 or more. In a more preferred embodiment, the thickness of the partition walls 25 is 0.14 to 0.30 mm, the cell density is 20 to 90 cells/cm², and the opening ratio of the cells 24 is 0.85 or more.

From the viewpoint of ensuring the strength of the honeycomb structure 21, the upper limit of the opening ratio of the cells 24 is preferably 0.94 or less, more preferably 0.92 or less, and even more preferably 0.90 or less.

Although the thickness of the outer peripheral wall 22 is not particularly limited, it is preferably determined based on the following considerations. First, from the viewpoint of reinforcing the honeycomb structure 21, the thickness of the outer peripheral wall 22 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer peripheral wall 22 is preferably 1.0 mm or less, more preferably 0.5 mm, even more preferably 0.4 mm or less, and still more preferably 0.3 mm or less.

As used herein, the thickness of the outer peripheral wall 22 refers to a length, in a normal line direction of a side surface of the honeycomb structure 21, from a boundary between the outer peripheral wall 22 and the outermost cell 24 or the partition wall 25 to the side surface of the honeycomb structure 21 in the cross section orthogonal to the flow path direction of the honeycomb structure 11.

The length of the honeycomb structure 21 in the flow path direction and the cross-sectional area orthogonal to the flow path direction may be adjusted according to the required size of the humidity controlling device 20, and are not particularly limited. For example, when used in a compact humidity controlling device 20 while ensuring a predetermined function, the honeycomb structure 21 can have a length of 2 to 20 mm in the flow path direction and a cross-sectional area of 10 cm² or more orthogonal to the flow path direction. Although the upper limit of the cross-sectional area orthogonal to the flow path direction of the honeycomb structure 21 is not particularly limited, it is, for example, 300 cm² or less

The partition walls 25 forming the honeycomb structure 21 are preferably made of a material that can be heated by electric conduction, specifically made of a material having a PTC property. Further, the outer peripheral wall 22 may also be made of a material having a PTC property, as with the partition walls 25, as needed. By such a configuration, the adsorbing layer 26 can be directly heated by heat transfer from the heat-generating partition walls 25 (and optionally the outer peripheral wall 22). Further, the material having the PTC property has characteristics such that when the temperature increases to exceed the Curie point, the resistance value is sharply increased, making it difficult for electricity to flow. Therefore, when the temperature of the partition walls 25 (and the outer peripheral wall 22 if necessary) becomes high, the current flowing through them is limited, thereby suppressing excessive heat generation of the honeycomb structure 21. Therefore, it is possible to suppress thermal deterioration of the adsorbing layer 26 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 30 Ω·cm or less, and more preferably 18 Ω·cm or less, and even more preferably 16 Ω·cm or less. As used herein, the volume resistivity at 25° C. of the material having the PTC property is measured according to JIS K 6271:2008.

From the viewpoints that can be heated by electric conduction and has the PTC property, the outer peripheral wall 22 and the partition walls 25 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ) TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

In terms of reduction of the environmental load, it is desirable that the materials used for the outer peripheral wall 22 and the partition walls 25 are substantially free of lead (Pb). Specifically, the outer peripheral wall 22 and the partition walls 25 preferably have a Pb content of 0.01% by mass or less, and more preferably 0.001% by mass or less, and still more preferably 0% by mass. The lower Pb content can allow the air heated by contact with the heat-generating partition walls 25 or the like to be safely applied to organisms such as humans, for example. In the outer peripheral wall 22 and the partition walls 25, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

The Curie point of the material making up the outer peripheral wall 22 and the partition walls 25 is preferably in a temperature range where the resistance value is twice or more the resistance at room temperature (25° C.). If the Curie point is in such a temperature range, the current flowing through the humidity controlling device 20 will be limited when the temperature of the humidity controlling device 20 becomes high, so that any excessive heat generation of the humidity controlling device 30 will be efficiently suppressed. Therefore, thermal deterioration of the adsorbing layer 26 caused by excessive heat generation can be suppressed.

In terms of efficiently heating the adsorbing layer 26, the material making up the outer peripheral wall 22 and the partition walls 25 preferably have a lower limit of a Curie point of 80° C. or more, more preferably 100° C. or more, even more preferably 110° C. or more, and still more preferably 125° C. or more. Further, in terms of safety as a component placed in the vehicle interior or near the vehicle interior, the upper limit of the Curie point is preferably 200° C. or more, more preferably 190° C. or more, even more preferably 180° C. or more, and still more preferably 150° C. or more.

The Curie point of the material making up the outer peripheral wall 22 and the partition walls 25 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC). A change in electrical resistance of the sample as a function of a temperature when the temperature is increased from 10° C. is measured using a DC resistance meter (e.g., Multimeter 3478A, from JAPAN HEWLETT PACKARD, LLC). Based on an electrical resistance-temperature plot obtained by the measurement, a temperature at which the resistance value is twice the resistance value at room temperature (25° C.) is defined as the Curie point.

### (2-2. Adsorbing Layer 26)

The adsorbing layer 26 contains an adsorbent.

The adsorbing layer 26 can be provided on the surfaces of the partition walls 25 (in the case of the outermost cells 24, the partition walls 25 that define the outermost cells 24 and the outer peripheral wall 22). By thus providing the adsorbing layer 26, the moisture is easily adsorbed during the moisture adsorption mode, and the adsorbing layer 26 can be easily heated during the regeneration mode, so that the moisture is easily separated.

The adsorbent contained in the adsorbing layer 26 is capable of adsorbing and separating the moisture. Also, the adsorbent can preferably adsorb and desorb carbon dioxide and/or volatile components, in addition to the moisture. By using such an adsorbent, it is possible to obtain the moisture adsorbing effects by the humidity controlling device 20 as well as purifying effects.

The adsorbent contained in the adsorbing layer 26 preferably has a function that can adsorb the moisture and the like at −20 to 60° C. and separate them at an elevated temperature of 60° C. or more.

Examples of the adsorbent include, but not limited to, aluminosilicate, silica gel, silica, graphene oxide, polymer adsorbents, polystyrene sulfonic acid, zeolite, activated carbon, alumina, low-crystalline clay, amorphous aluminum silicate composites, and metal organic frameworks (MOFs). These may be used alone or in combination of two or more.

Examples of the aluminosilicate that can be preferably used herein include AFI type-, CHA type-, or BEA type-zeolite; porous clay minerals such as allophane and imogolite. Also, it is more preferable that the aluminosilicate is amorphous.

As the silica gel, type A silica gel is preferably used.

Examples of the polymer adsorbent that can be preferably used herein include a polymer adsorbent having a polyacrylic acid polymer chain. For example, sodium polyacrylate or the like can be used as the polymer adsorbent.

The metal organic framework is a crystalline hybrid material containing metal ions and organic molecules (organic ligands). The metal ions are preferably hydrophilic metal ions (for example, aluminum ions).

The volatile components in the air in the vehicle interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The adsorbing layer 26 can further contain a catalyst. By containing the catalyst, it is possible to promote oxidation-reduction reaction and the like to purify carbon dioxide and/or volatile components. The catalyst having such a function includes metal catalysts such as Pt, Pd and Ag, and oxide catalysts such as CeO₂ and ZrO₂. The catalyst may be used alone or in combination of two or more types. The catalyst may also be used in combination with the functional material as described above.

The thickness of the adsorbing layer 26 may be determined according to the size of the cells 24, and is not particularly limited. For example, from the viewpoint of ensuring sufficient contact with air, the thickness of the adsorbing layer 26 is preferably 20 μm or more, more preferably 25 μm or more, and even more preferably 30 μm or more. On the other hand, from the viewpoint of suppressing separation of the adsorbing layer 26 from the partition walls 25 and the outer peripheral wall 22, the thickness of the adsorbing layer 26 is preferably 400 μm or less, more preferably 380 μm or less, and even more preferably 350 μm or less.

The thickness of the adsorbing layer 26 is measured using the following procedure. Any cross section of the honeycomb structure 21 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 21. The thickness of each adsorbing layer 26 visually recognized from the cross-sectional image is calculated by dividing the cross-sectional area by the length of the cells 24 in the flow path direction. This calculation is performed for all the adsorbing layers 26 visually recognized from the cross-sectional image, and an average value thereof is determined to be the thickness of the adsorbing layer 26.

From the viewpoint of exerting a desired function in the humidity controlling device 20, an amount of the adsorbing layer 26 is preferably 50 to 500 g/L, more preferably 100 to 400 g/L, and even more preferably 150 to 350 g/L, based on the volume of the honeycomb structure 21. It should be noted that the volume of the honeycomb structure 21 is a value determined by the external dimensions of the honeycomb structure 21.

In the regeneration mode of the adsorbing layer 26, the adsorbing layer 26 is preferably heated at a temperature higher than or equal to the separating temperature depending on the type of the adsorbent in order to promote the separation of the moisture captured by the adsorbing layer 26. For example, it is more preferable to heat the adsorbing layer 26 at 70 to 150° C., even more preferably 80 to 140° C., and still more preferably 90 to 130° C.

### (2-3. Pair of Electrodes 27a, 27b)

A pair of electrodes 27a, 27b may be provided on the first end face 23a and the second end face 23b of the honeycomb structure 21, respectively, as illustrated in FIG. 3A, although the positions of the electrodes 17a, 17b are not limited thereto. Also, the pair of electrodes 27a, 27b may be provided on the outer peripheral wall 22 parallel to the extending direction of the cells 24 of the honeycomb structure 21.

Applying of a voltage between the pair of electrodes 27a, 27b allows the honeycomb structure 21 to generate heat by Joule heat.

The pair of electrodes 27a, 27b may employ, for example, a metal or alloy containing at least one selected from Cu, Ag, Al, Ni and Si, although not particularly limited thereto. It is also possible to use an ohmic electrode capable of ohmic contact with the outer peripheral wall 22 and/or the partition walls 25 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 27a, 27b may have a single-layer structure, or may have a laminated structure of two or more layers. When the pair of electrodes 27a, 27b have the laminated structure of two or more layers, the materials of the respective layers may be of the same type or of different types.

The thickness of the pair of electrodes 27a, 27b may be appropriately set according to the method for forming the pair of electrodes 27a, 27b. The method for forming the pair of electrodes 27a, 27b includes metal deposition methods such as sputtering, vapor deposition, electrolytic deposition, and chemical deposition. Alternatively, the pair of electrodes 27a, 27b can be formed by applying an electrode paste and then baking it, or by thermal spraying. Furthermore, the pair of electrodes 27a, 27b may be formed by joining metal sheets or alloy sheets.

Each of the thicknesses of the pair of electrodes 27a, 27b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (2-4. Terminal 28)

The terminals 28 are connected to the pair of electrodes 27a, 27b and provided on at least a part of the pair of electrodes 27a, 27b. The provision of the terminals 28 facilitates connection to an external power supply. The terminals 28 are connected to a conductor connected to the external power supply.

The terminals 28 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 28 are not particularly limited. For example, as illustrated in FIG. 6A, the terminals 28 can be provided on the whole of the pair of electrodes 27a, 27b on the outer peripheral wall 22. Further, the terminals 28 may be provided on a part of the pair of electrodes 27a, 27b on the outer peripheral wall 22, or may be provided so as to extend toward an outer side than the outer edge of each of the pair of electrodes 27a, 27b on the outer peripheral wall 22. Further, the terminals 28 may be provided on a part of the pair of electrodes 27a, 27b on the partition walls 25, or may be provided so as to block a part of the cells 24.

Furthermore, the thickness of the terminal 28 is not particularly limited, but it is, for example, 0.01 to 10 mm, typically 0.05 to 5 mm.

The method of connecting the terminals 28 to the pair of electrodes 27a, 27b is not particularly limited as long as they are electrically connected. For example, they can be connected by diffusion bonding, a mechanical pressing mechanism, welding, or the like.

### (2-5. Method for Producing Humidity Controlling Device 20)

The method for producing the humidity controlling device 20 according to the embodiment of the present invention is not particularly limited, and it can be performed according to a known method. Hereinafter, the method for producing the humidity controlling device 20 according to an embodiment of the present invention will be illustratively described.

A method for producing the honeycomb structure 21 forming the humidity controlling device 20 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 21 containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure 21 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 21.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. The maintaining at 900 to 950° C. for 0.5 to 5 hours can lead to sufficient decomposition of BaCO₃, so that the honeycomb structure 21 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost. A firing furnace used in the firing step and the degreasing step is not particularly limited, but it may be an electric furnace, a gas furnace, or the like.

On the honeycomb structure 21 thus obtained, the pair of electrodes 27a, 27b are formed. The pair of electrodes 27a, 27b can be formed by metal deposition methods such as sputtering, vapor deposition, electrolytic deposition, and chemical deposition. Further, the pair of electrodes 27a, 27b can also be formed by applying an electrode paste and then baking it. Furthermore, the pair of electrodes 27a, 27b can also be formed by thermal spraying. The pair of electrodes 27a, 27b may be composed of a single layer, but may also be composed of a plurality of electrode layers having different compositions. A typical method for forming the pair of electrodes 27a, 27b will be described below.

First, an electrode slurry containing an electrode material, an organic binder, and a dispersion medium is prepared, and the first end face 23a or the second end face 23b of the honeycomb structure 21 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 21 is removed by blowing and wiping. The slurry can be then dried to form the pair of electrodes 27a, 27b on the first end face 24a or the second end face 23b of the honeycomb structure 21. The drying can be performed while heating the honeycomb structure 21 to a temperature of about 120 to 600° C., for example. Although a series of steps of coating, slurry removal, and drying may be performed only once, the steps can be repeated multiple times to provide the pair of electrodes 27a, 27b having desired thicknesses.

The terminals 28 are then provided at predetermined positions of the pair of electrodes 27a, 27b, and the pair of electrodes 27a, 27b and the terminals 28 are connected to each other. As a method of connecting the pair of electrodes 27a, 27b to the terminals 28, the method described above can be used.

It should be noted that the terminals 28 may be placed after forming an adsorbing layer 26 described below.

The adsorbing layer 26 is then formed on the surfaces of the partition walls 25 and the like of the honeycomb structure 21.

Although the method for forming the adsorbing layer 26 is not particularly limited, it can be formed, for example, by the following steps. The honeycomb structure 21 is immersed in a slurry containing an adsorbent, a binder, and a dispersion medium for a predetermined period of time, and an excess slurry on the end faces and the outer periphery of the honeycomb structure 21 is removed by blowing and wiping. The binder may be an organic binder or an inorganic binder, or a combination thereof. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorbing layer 26 on the surfaces of the partition walls 25 and the like. The drying can be performed while heating the honeycomb structure 21 to a temperature of about 120 to 600° C., for example. Although a series of steps of immersion, slurry removal, and drying may be performed only once, the steps can be repeated multiple times to provide the adsorbing layer 26 having the desired thickness on the surfaces of the partition walls 25 and the like.

### (2-6. Humidity Controlling Device 20)

The humidity controlling device 20 has a flow path for the air and a flow path for a heating medium adjacent to the flow path for the air, and the adsorption portion is provided in the flow path for the air. The humidity controlling device 20 having such a structure includes a plate-fin type heat exchanger provided with a plurality of fins on a pipe and an aerofin type heat exchanger having the adsorbing layer 26 on each surface of the fins.

In the humidity controlling device 20 having the above structure, the air flows between the fins and the heating medium flows through the pipe. The fins are heated by the flow of the heating medium, so that the adsorbing layer 26 provided on each surface of the fins can be heated.

The humidity controlling device 20 having the structure as described above can be produced by using a commercially available plate fin type heat exchanger or aerofin type heat exchanger to form the adsorbing layer 26 on the surfaces of the fins. The adsorbing layer 26 may be formed by the method as described above.

The humidity controlling device 20 may include: a honeycomb structure 21 having an outer peripheral wall 22 and partition walls 25 provided on an inner side of the outer peripheral wall 22, the partition walls 25 defining a plurality of cells 24 each extending from a first end face 23a to a second end face 23b of the honeycomb structure 21 to form a flow path for air; an adsorbing layer 26 containing an adsorbent, the adsorbing layer 26 being provided on a surface of each of the partition walls 25; and a heater provided on an upstream side of the honeycomb structure 21. It should be noted that the structure of the humidity controlling device 20 corresponds to the structure in which the pair of electrodes 27a, 27b and the terminals 28 are removed in FIG. 6A.

In the humidity controlling device 20 having the heating structure as described above, the adsorbing layer 26 provided on each surface of the partition walls 25 can be heated by allowing the air heated by the heater to flow through the cells 24 of the honeycomb structure 21.

The humidity controlling device 20 having the heating structure as described above can be formed from various materials such as metals and ceramics, because the honeycomb structure 21 itself is not required to generate heat by electrical conduction. The honeycomb structure 21 may be made of a material that can be heated by electrical conduction.

The humidity controlling device 20 having the heating structure as described above can be produced according to the method as described above.

### (3. HVAC Unit 30)

The HVAC unit can include an evaporator 31 provided in the flow path 10 on a downstream side of the humidity controlling device 20. The evaporator 31 can cool and dehumidify the air flowing through the HVAC unit 30.

Also, the HVAC unit 30 may include a condenser 32 for heating the air flowing through the HVAC unit 30. Although the position of the condenser 32 is not particularly limited, it can be provided in the flow path 10 on a downstream side of the evaporator 31, for example.

The HVAC unit 30 can include a defroster opening 33a, a foot opening 33b, and a face opening 33c, which are opened toward the vehicle interior on a downstream side of the evaporator 31 and the condenser 32. It can also include a defroster door 34a for adjusting an amount of air blowing out of the defroster opening 33a, a foot door 34b for adjusting an amount of air blowing out of the foot opening 33b, and a face door 34c for adjusting an amount of air blowing out of the face opening 33c.

In the case of the vehicle air conditioning system illustrated in FIGS. 1, 2 and 5, the HVAC unit 30 can include a ventilation fan 50 (blower). Specifically, in the case of the vehicle air conditioning system illustrated in FIG. 1, the HVAC unit 30 can include the ventilation fan 50 in each of the third flow path 13 that is provided with the humidity controlling device 20 and the fourth flow path 14 that is not provided with the humidity controlling device 20. In the case of the vehicle air conditioning system illustrated in FIG. 2, the HVAC unit 30 can include the ventilation fan 50 in the flow path 10 on an upstream side of the third flow path 13 and the fourth flow path 14. In the case of the vehicle air conditioning system illustrated in FIG. 5, the HVAC unit 30 can include the ventilation fan 50 in the flow path 10 on an upstream side of the evaporator 31.

In addition, the ventilation fan 50 is not particularly limited, and any known ventilation fan can be used.

On the other hand, in the case of the vehicle air conditioning system illustrated in FIGS. 3 and 4, the ventilation fan 50 is provided in the flow path 10 in a duct 15 that is different from that of the HVAC unit 30. In the case of the vehicle air conditioning system illustrated in FIG. 5, in addition to the HVAC unit 30, the ventilation fan 50 is also provided in the flow path 10 in the duct 15. Specifically, in the case of the vehicle air conditioning system illustrated in FIG. 3, in the flow path 10 in the duct 15 on the upstream side of the HVAC unit 30, the ventilation fan 50 can be included in each of the third flow path 13 that is provided with the humidity controlling device 20 and the fourth flow path 14 that is not provided with the humidity controlling device 20. Also, in the case of the vehicle air conditioning system illustrated in FIG. 4, in the flow path 10 in the duct 15 on the upstream side of the HVAC unit 30, the ventilation fan 50 can be included in the flow path 10 on the upstream side of the third flow path 13 and the fourth flow path 14. In the case of the vehicle air conditioning system illustrated in FIG. 5, the ventilation fan 50 can be included in the third flow path 13 on the upstream side of the humidity controlling device 20.

In the case of the vehicle air conditioning system illustrated in FIGS. 1, 2 and 5, the HVAC unit 30 can include an inside air feed port 51a for feeding the inside air, an outside air feed port 51b for feeding the outside air, and a damper 52 for adjusting flow rates of the inside air and the outside air.

On the other hand, in the case of the vehicle air conditioning system illustrated in FIGS. 3 and 4, the duct 15 on the upstream side of the HVAC unit 30 can include an inside air feed port 51a for feeding the inside air, an outside air feed port 51b for feeding the outside air, and a damper 52 for adjusting flow rates of the inside air and the outside air.

The HVAC unit 30 may include an air mix door 39 between the evaporator 31 and the condenser 32.

The air mix door 39 is configured to be rotated in the flow path 10 in the HVAC unit 30 between a heating position that opens a heating path toward the condenser 32 and a cooling position that opens a cooling path that bypasses the condenser 32. Furthermore, by rotating the air mix door 39 between the heating position and the cooling position, it can adjust a ratio of the air passing through the condenser 32 to the air bypassing the condenser 32, thereby adjusting the temperature of the air flowing into the vehicle interior.

The evaporator 31 and the condenser 32 of the HVAC unit 30 can be connected to the heat pump cycle.

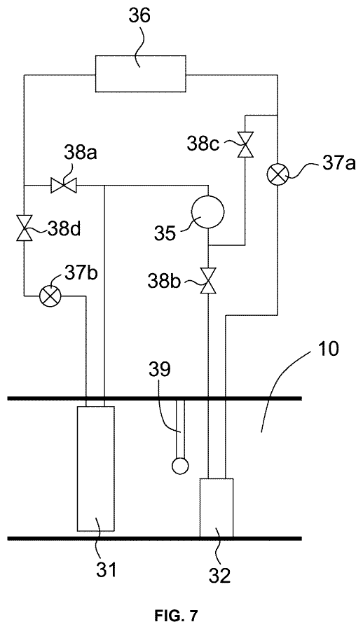

Here, FIG. 7 illustrates a schematic view of the heat pump cycle connected to the evaporator 31 and the condenser 32.

In the heat pump cycle, the evaporator 31 can exchange heat between the cold of the refrigerant and the air. Specifically, the evaporator 31 is capable of absorbing the heat by a low-temperature, low-pressure refrigerant flowing through the heat pump cycle, and cools the air in the flow path, which passes around the evaporator 31. The condenser 32 can also exchange heat between the refrigerant and the air. Specifically, the condenser 32 is capable of dissipating the heat by a high-temperature, high-pressure refrigerant flowing through the heat pump cycle, and heats the air in the flow path 10, which passes around the condenser 32.

The heat pump cycle can further include: a compressor 35; an outdoor heat exchanger 36; expansion valves 37a, 37b; and shutoff valves 38a to 38d. Each of these members is connected via the refrigerant flow path.

The compressor 35 has a function of compressing and discharging the refrigerant. The compressor 35 has a suction portion connected to the outdoor heat exchanger 36, and a discharge portion connected to the condenser 32 via the refrigerant flow path. The compressor 35 is driven by the control unit 40 and discharges the high-temperature, high-pressure refrigerant to the condenser 32 by compressing the refrigerant.

It should be noted that a known device such as a gas-liquid separator may be provided between the compressor 35 and the outdoor heat exchanger 36.

The outdoor heat exchanger 36 has a function of performing heat exchange between the heat of the refrigerant and the outside air. The outdoor heat exchanger 36 can absorb the heat from the outside air using a low-temperature, low-pressure refrigerant flowing therethrough, mainly when executing the heating operation mode, and can vaporize the refrigerant by absorbing the heat from the outside air. Moreover, the outdoor heat exchanger 36 can release the heat to the outside air by the high-temperature, high-pressure refrigerant flowing therethrough, and cools the refrigerant by releasing the heat to the outside air, mainly when executing the cooling operation mode.

The expansion valves 37a, 37b are throttle valves whose opening degrees can be adjusted by the control unit 40. In particular, when the heating operation mode is executed, the expansion valve 37a reduces the pressure of the refrigerant discharged from the condenser 32 to expand it, and then discharges the low-temperature, low-pressure refrigerant to the outdoor heat exchanger 36. Furthermore, when the cooling operation mode is executed, the expansion valve 37b reduces the pressure of the refrigerant from the outdoor heat exchanger 36 to expand it, and then discharge the low-temperature, low-pressure refrigerant to the evaporator 31.

The shutoff valves 38a to 38d are provided to control the flow path of the refrigerant. The opening and closing of the shutoff valves 38a to 38d are controlled by the control unit 40.

### (4. Control Unit 40)

The control unit 40 controls the humidity controlling device 20 and the HVAC unit 30 (including the heat pump cycle) depending on the operation mode. Therefore, the control unit 40 is electrically connected to the humidity controlling device 20 and the HVAC unit 30. That is, the control unit 40 can control the humidity controlling device 20 to execute a dehumidification mode or a regeneration mode. The control unit 40 can also control the HVAC unit 30 to execute a heating operation mode or a cooling operation (dehumidification) mode.

The control unit 40 is electrically connected to the shutoff valves 38a to 38d of the heat pump cycle, and can control the refrigerant flow path by opening and closing the shutoff valves 38a to 38d. Further, the control unit 40 is electrically connected to the expansion valves 37a, 37b of the heat pump cycle, and can control the degree of pressure reduction of the refrigerant by adjusting the opening degrees of the expansion valves 37a, 37b. Furthermore, the control unit 40 is also electrically connected to the air mix door 39, the ventilation fan 50, the first valve 60, the second valve 61, and the like, and can control these members.

The control unit 40 is generally an ECU (Engine (electronic) Control Unit), although not particularly limited thereto. The ECU is a CPU for executing various calculation processes, a ROM for storing programs and data required for its control, a RAM for temporarily storing results of calculations performed by the CPU, and input/output ports for inputting and outputting signals to and from the outside.

In the vehicle air conditioning system according to an embodiment of this invention, the control unit 40 can execute a dehumidification mode and a regeneration mode as operation modes of the humidity controlling device 20.

### <Dehumidification Mode>

In the vehicle air conditioning system illustrated in FIGS. 1 and 3, dehumidification is executed by activating the ventilation fan 50 provided in the third flow path 11, controlling the first valve 60 so that the air flows into the first flow path 11, and allowing the air to flow through the humidity controlling device 20.

In the vehicle air conditioning system illustrated in FIGS. 2 and 4, dehumidification is executed by activating the ventilation fan 50, controlling the second valve 61 so that the air flows into the third flow path 13, controlling the first valve 60 so that the air flows into the first flow path 11, thereby allowing the air to flow through the humidity controlling device 20.

Furthermore, in the vehicle air conditioning system illustrated in FIG. 5, dehumidification is executed by activating the ventilation fan 50 in the HVAC unit 30, controlling the first valve 60 so that the air flows into the first flow path 11, thereby allowing the air to flow through the humidity controlling device 20. At this time, the ventilation fan 50 provided in the third flow path 13 may be activated.

In the dehumidification mode, the humidity controlling device 20 is not heated.

### <Regeneration Mode>

In the vehicle air conditioning system illustrated in FIGS. 1, 3 and 5, the air is allowed to flow through the humidity controlling device 20 by activating the ventilation fan 50 provided in the third flow path 13 to allow the air to flow into the third flow path 13, and controlling the first valve 60 so that the air flows into the second flow path 12. At this time, by heating the humidity controlling device 20, the moisture adsorbed in the humidity controlling device 20 is desorbed, so that the humidity controlling device 20 can be regenerated.

In the vehicle air conditioning system illustrated in FIGS. 2 and 4, the air is allowed to flow through the humidity controlling device 20 by activating the ventilation fan 50, controlling the second valve 61 so that the air flows into the third flow path 13, and controlling the first valve 60 so that the air flows into the second flow path 12. At this time, by heating the humidity controlling device 20, the moisture adsorbed in the humidity controlling device 20 is desorbed, so that the humidity controlling device 20 can be regenerated.

In the vehicle air conditioning system according to an embodiment, the control unit 40 can execute the heating operation mode and the cooling operation mode as operation modes of the HVAC unit 30.

### <Heating Operation Mode>

The heating operation mode opens the shutoff valves 38a and 38b and closes the shutoff valves 38c and 38d, thereby forming a flow path such that the refrigerant sequentially flows through the compressor 35, the condenser 32, the expansion valve 37a, and the outdoor heat exchanger 36.

The refrigerant compressed by the compressor 35 enters the condenser 32 as a high-temperature, high-pressure refrigerant, exchanges heat with the air flowing through the flow path 10 in the HVAC unit 30, and releases the heat. The refrigerant that has left the condenser 32 is pressure-reduced and expanded by the expansion valve 37a to form a low-temperature, low-pressure refrigerant, and then exchanges the heat with the outside air in the outdoor heat exchanger 36 to absorb the heat, and returns to the compressor 35.

When this heating operation mode is executed, the air flowing through the flow path 10 in the HVAC unit 30 is heated by the condenser 32, and the heated air is allowed to flow into the vehicle interior. The temperature of the air flowing into the vehicle interior can be adjusted by controlling the opening degree of the air mix door 39.

### <First Cooling Operation Mode>

The cooling operation mode opens the shutoff valves 38c, 38d and closes the shutoff valves 38a and 38b, thereby forming a flow path such that the refrigerant sequentially flows through the compressor 35, the outdoor heat exchanger 36, the expansion valve 37b and the evaporator 31.

The refrigerant compressed by the compressor 35 to a high temperature and a high pressure is cooled by exchanging heat with the outside air and releasing the heat in the outdoor heat exchanger 36. The refrigerant that has left the outdoor heat exchanger 36 is pressure-reduced and expanded by the expansion valve 37b to form a low-temperature, low-pressure refrigerant, which enters the evaporator 31, and exchanges the heat with the air flowing through the flow path 10 in the HVAC unit 30 to absorb the heat. The refrigerant that has left the evaporator 31 returns to the compressor 35.

When the cooling operation mode is executed, the air flowing through the flow path 10 in the HVAC unit 30 is cooled by the evaporator 31, and the cooled air flows into the vehicle interior. The cooling operation mode is particularly useful when it is desired to rapidly cool the vehicle interior (strong cooling operation mode).

### <Second Cooling Operation Mode>

The second cooling operation mode opens the shutoff valves 38b, 38d and closes the shutoff valves 38a and 38c, thereby forming a flow path such that the refrigerant sequentially flows through the compressor 35, the condenser 32, the expansion valve 37a, the outdoor heat exchanger 36, the expansion valve 37b and the evaporator 31.

The condenser 32 and the expansion valve 37a are further provided on a downstream side of the compressor 35 in the refrigerant flow path in this cooling operation mode. In the cooling operation mode, the cooling of the air by the evaporator 31 and the heating of the air by the condenser 32 can be adjusted by controlling the opening degree of the air mix door 39, so that the temperature of the air can be controlled to the optimum temperature.

### EXAMPLES

Hereinafter, the present invention will be more specifically described with reference to Examples, but the present invention is not limited to these Examples.

Assuming the vehicle air conditioning system including the humidity controlling device and the HVAC unit as illustrated in FIG. 2, the amount of power consumption required for heating by the HVAC unit was determined by changing the percentage of the amount of the inside air introduced, at a temperature of the outside air of −10° C., at a heating set temperature of 20° C., and at the total flow rate of the air (outside air and inside air) introduced into the flow path (in the HVAC unit) of 300 m³/h. For example, when the percentage of the amount of the inside air introduced was 40%, the flow rate of the inside air was 120 m³/h and the flow rate of the outside air was 180 m³/h. The electricity consumption required for heating was determined by the following equation:

Power consumption [W]=flow rate of outside air [m³/s]×air density [kg/m³]×air specific heat [J/kg K]×amount of air increased [° C.]

In the equation, the density and specific heat of the air were calculated based on the temperature of the air (inlet temperature) measured by a temperature sensor placed at the inlet of the HVAC unit. Further, a temperature sensor was further placed at the outlet of the HVAC unit, the amount of the temperature of the air increased was calculated based on temperatures of the air (inlet temperature and outlet temperature) measured by temperature sensors at the inlet and the outlet of the HVAC unit.

In this evaluation, a power consumption of 3500 W or less can be determined to be a very low power consumption, a power consumption of more than 3500 W and less than or equal to 4000 W can be determined to a lower power consumption, and a power consumption of more than 4000 W can be determined to be a higher power consumption.

The above results are shown in Table 1.

TABLE 1

| | | power |
|---|---|---|
| | Percentage of Inside | Consumption |
| | Air Introduced [%] | [W] |
| Ex. 1 | 55 | 4000 |
| Ex. 2 | 70 | 3450 |
| Ex. 3 | 90 | 2800 |
| Comp. 1 | 40 | 4500 |

As shown in Table 1, Examples 1 to 3 in which the amount of the inside air introduced was controlled to be greater than the amount of the outside air introduced had a lower power consumption than Comparative Example 1 in which the amount of the inside air introduced was controlled to be less than the amount of the outside air introduced.

As can be seen from the above results, according to this invention, it is possible to provide a vehicle air conditioning system that can reduce the energy consumption while ensuring suitable dehumidification performance during heating.

### DESCRIPTION OF REFERENCE NUMERALS

10 flow path
11 first flow path
12 second flow path
13 third flow path
14 fourth flow path
15 duct
20 humidity controlling device
21 honeycomb structure
22 outer peripheral wall
23a first end face
23b second end face
24 cell
25 partition wall
26 adsorbing layer
27a, 27b pair of electrodes
28 terminal
30 HVAC unit
31 evaporator
32 condenser
33a defroster opening
33b foot opening
33c face opening
34a defroster door
34b foot door
34c face door
35 compressor
36 outdoor heat exchanger
37a, 37b expansion valve
38a-38d shutoff valve
39 air mix door
40 control unit
50 ventilation fan
51a inside air feed port
51b outside air feed port
52 damper
60 first valve
61 second valve

1. A vehicle air conditioning system comprising:
a flow path through which inside air in a vehicle interior and/or outside air from a vehicle exterior can flow;
at least one humidity controlling device provided in the flow path, the humidity controlling device being configured to adsorb and desorb moisture;
an HVAC unit comprising a damper configured to adjust a percentage of an amount of the inside air and an amount of the outside air introduced; and
a control unit configured to control the humidity controlling device and the HVAC unit,
wherein the control unit controls the damper so that the amount of the inside air introduced is greater than the amount of the outside air introduced, during execution of heating by the HVAC unit and dehumidification by the humidity controlling device.

2. The vehicle air conditioning system according to claim 1, wherein the control unit controls the damper so that a percentage of the amount of the inside air introduced is 55% or more, during execution of the heating by the HVAC unit and the dehumidification by the humidity controlling device.

3. The vehicle air conditioning system according to claim 1, wherein the control unit controls the damper so that a percentage of the amount of the inside air introduced is 70% or more, during execution of the heating by the HVAC unit and the dehumidification by the humidity controlling device.

4. The vehicle air conditioning system according to claim 1, wherein the humidity controlling device is provided on a downstream side of the damper in the HVAC unit.

5. The vehicle air conditioning system according to claim 1, wherein the humidity controlling device is provided on an upstream side of the HVAC unit.

6. The vehicle air conditioning system according to claim 1, wherein the HVAC unit comprises a condenser, and the condenser is connected to a heat pump cycle.

7. The vehicle air conditioning system according to claim 1, wherein, on a downstream side of the humidity controlling device, the flow path branches into a first flow path for allowing the inside air and/or the outside air to flow into the vehicle interior and a second flow path for allowing the inside air and/or the outside air to flow to the vehicle exterior, and
wherein the vehicle air conditioning system further comprises a first valve configured to switch the flow of the inside air and/or the outside air between the first flow path and the second flow path.

8. The vehicle air conditioning system according to claim 1, wherein the humidity controlling device comprises: an adsorption portion containing an adsorbent configured to adsorb moisture at a temperature lower than or equal to a predetermined temperature and desorb the adsorbed moisture when the temperature exceeds the predetermined temperature; and a heating means or a heating structure configured to heat the adsorption portion.

9. The vehicle air conditioning system according to claim 8, wherein the humidity controlling device comprises:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for air;
an adsorbing layer containing the adsorbent, the adsorbing layer being provided on a surface of each of the partition walls; and
a pair of electrodes provided on the first end face and the second end face of the honeycomb structure, or on the outer peripheral wall parallel to an extending direction of the cells of the honeycomb structure.

10. The vehicle air conditioning system according to claim 9, wherein at least the partition walls of the honeycomb structure are made of a material having a positive temperature coefficient (PTC) property.

11. The vehicle air conditioning system according to claim 8, wherein the humidity controlling device has a flow path for air and a flow path for a heating medium adjacent to the flow path for the air, and wherein the adsorption portion is provided in the flow path for the air.

12. The vehicle air conditioning system according to claim 8, wherein the humidity controlling device comprises:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for air;
an adsorbing layer containing the adsorbent, the adsorbing layer being provided on a surface of each of the partition walls; and
a heater provided on an upstream side of the honeycomb structure.

13. The vehicle air conditioning system according to claim 1, wherein the vehicle air conditioning system is used for an electric vehicle, a hybrid vehicle, or a plug-in hybrid vehicle.
